(19) United States
(12) Patent Application Publication
(10) Pub. No.: US 2026/0177421 A1
(43) Pub. Date: Jun. 25, 2026

(54) DETECTION DEVICE

(71) Applicant: Japan Display Inc., Tokyo (JP)

(72) Inventors: Yoshiro AOKI, Tokyo (JP); Takanori TSUNASHIMA, Tokyo (JP)

(21) Appl. No.: 19/431,045

(22) Filed: Dec. 23, 2025

(30) Foreign Application Priority Data
Dec. 24, 2024 (JP) 2024-227506

(51) Int. Cl. G01J 1/02; G01J 1/04; G01J 1/08

(52) U.S. Cl. CPC G01J 1/0219; G01J 1/0403; G01J 1/08

(57) ABSTRACT

According to an aspect, a detection device includes: a sensor panel having a detection area in which optical sensors are arranged; a light source configured to emit light; a member on which an object to be detected is to be placed so that the object to be detected is interposed between the detection area and the light source; and a flexible printed circuit provided with wiring configured to transmit signals to be transmitted between the sensor panel and a circuit outside the sensor panel. A first terminal is a conductor coupled to wiring provided on the sensor panel and is covered by an insulting layer. The first terminal faces a second terminal that is a conductor provided on the flexible printed circuit correspondingly to the first terminal and coupled to the wiring of the flexible printed circuit, with the insulating layer interposed between the first and second terminals.

### CROSS-REFERENCE TO RELATED APPLICATION

This application claims the benefit of priority from Japanese Patent Application No. 2024-227506 filed on Dec. 24, 2024, the entire contents of which are incorporated herein by reference.

### BACKGROUND

### 1. Technical Field

What is disclosed herein relates to a detection device.

### 2. Description of the Related Art

Detection devices are known that enable detection of states of culture environments for culturing biological tissues or microorganisms using an optical sensor (for example, Japanese Patent Application Laid-open Publication No. 2019-004813).

In a configuration in which wiring is simply coupled to the sensor panel provided with an optical sensor, coupling points between the sensor panel and the wiring may corrode to cause faulty connection such as disconnection. In particular, since the culture environments for culturing biological tissues or microorganisms are placed at temperature and humidity suitable for their growth, the corrosion may more easily progress depending on the temperature and the humidity. Therefore, detection devices are required that can reduce defects in electrical transmission paths between the sensor panel and the wiring caused by the corrosion.

For the foregoing reasons, there is need for a detection device capable of reducing the defects in electrical transmission paths between the sensor panel and the wiring caused by corrosion.

### SUMMARY

According to an aspect, a detection device includes: a sensor panel that has a detection area in which a plurality of optical sensors are two-dimensionally arranged; a light source configured to emit light; a member on which an object to be detected is to be placed so that the object to be detected is interposed between the detection area and the light source; and a flexible printed circuit provided with wiring configured to transmit signals to be transmitted between the sensor panel and a circuit outside the sensor panel. A first terminal that is a conductor coupled to wiring provided on the sensor panel is covered by an insulting layer. The first terminal and a second terminal face each other with the insulating layer interposed between the first terminal and the second terminal, and the second terminal is a conductor that is provided on the flexible printed circuit correspondingly to the first terminal and is coupled to the wiring of the flexible printed circuit.

### BRIEF DESCRIPTION OF THE DRAWINGS

FIG. 1 is a diagram illustrating a main configuration of a detection device;

FIG. 2 is a diagram illustrating a configuration example of a detection area and a wiring area;

FIG. 3 is a circuit diagram illustrating a circuit configuration of an optical sensor;

FIG. 4 is a schematic diagram schematically illustrating a configuration example of a detection system;

FIG. 5 is a schematic diagram illustrating a relation between one detection device and an external configuration;

FIG. 6 is a schematic view illustrating a configuration inside a case and a relation between a sensor panel and flexible printed circuits (FPC);

FIG. 7 is a sectional view illustrating a specific example of a first terminal, an insulating layer, a second terminal, and a configuration around these components;

FIG. 8 is a schematic view illustrating a configuration of the first terminal;

FIG. 9 is a schematic view illustrating a configuration of the second terminal;

FIG. 10 is a schematic view illustrating a facing relation between a coil 210 and a coil 310 and a facing relation between a terminal 220 and a terminal 320;

FIG. 11 is a schematic view illustrating the coil 210 and the coil 310 of a power transmitter;

FIG. 12 is a schematic conceptual diagram illustrating a basic relation between the terminals 220 and 320 of a signal transmitter;

FIG. 13 is a view illustrating an example of a more specific configuration provided in the signal transmitter;

FIG. 14 selectively illustrates three of a plurality of terminals 221 and three of a plurality of terminals 321 illustrated in FIG. 13;

FIG. 15 is a view illustrating an example of a gripping member;

FIG. 16 is a view illustrating rotation of a movable portion illustrated in FIG. 15;

FIG. 17 is a view illustrating the gripping member after completion of the rotation of the movable portion illustrated in FIG. 16;

FIG. 18 is a schematic view illustrating a reference example in which the sensor panel is physically directly coupled to the FPC via a coupling member 1001;

FIG. 19 is a view illustrating a specific configuration of the coupling member 1001 illustrated in FIG. 18 and degradation of the coupling member 1001 by an optical sensor WA;

FIG. 20 is a view illustrating an example of a specific configuration provided in the signal transmitter in a modification of the embodiment;

FIG. 21 selectively illustrates three of a plurality of terminals 222 and three of a plurality of terminals 322 illustrated in FIG. 20;

FIG. 22 is a view illustrating rectangular terminals 223 and 323 that differ from the terminals 222 and 322 illustrated in FIG. 21 in a relative relation between a width in a first direction Dx and a width in a second direction Dy;

FIG. 23 is a graph illustrating a relation between a total width and a coupling capacitance size;

FIG. 24 is a sectional view of a configuration interposed between the first and the second terminals in a third modification of the embodiment;

FIG. 25 is a sectional view of a configuration interposed between the first and the second terminals in a fourth modification of the embodiment; and

FIG. 26 is a sectional view of a configuration interposed between the first and the second terminals in a fifth modification of the embodiment.

### DETAILED DESCRIPTION

The following describes an embodiment of the present disclosure with reference to the drawings. What is disclosed herein is merely an example, and the present disclosure naturally encompasses appropriate modifications easily conceivable by those skilled in the art while maintaining the gist of the present invention. To further clarify the description, the drawings may schematically illustrate, for example, widths, thicknesses, and shapes of various parts as compared with actual aspects thereof. However, they are merely examples, and interpretation of the present disclosure is not limited thereto. The same element as that illustrated in a drawing and the present specification that has already been discussed is denoted by the same reference numeral through the description and the drawings, and detailed description thereof may not be repeated where appropriate.

### Embodiment

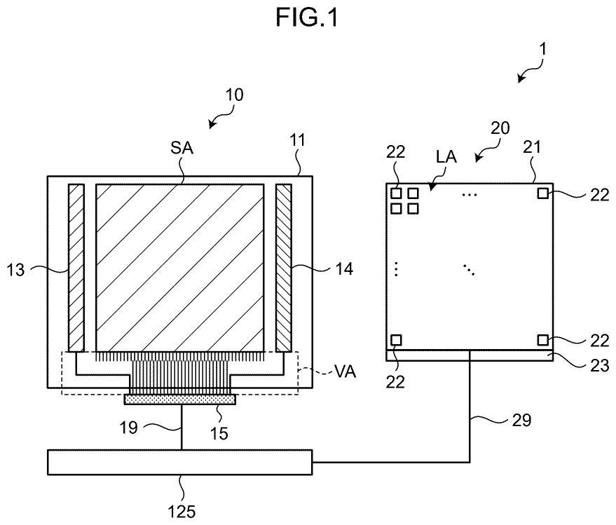

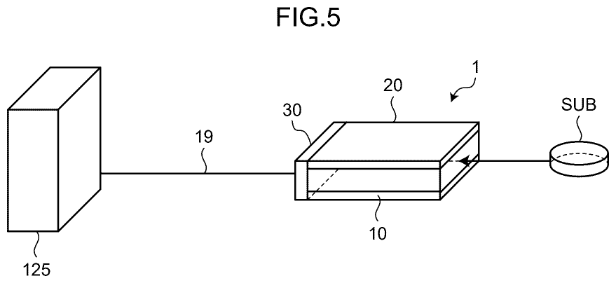

FIG. 1 is a diagram illustrating a main configuration of a detection device 1. The detection device 1 includes a sensor panel 10 and a light source panel 20. The sensor panel 10 and the light source panel 20 of the detection device 1 are coupled to a control device 125 (refer to FIG. 5).

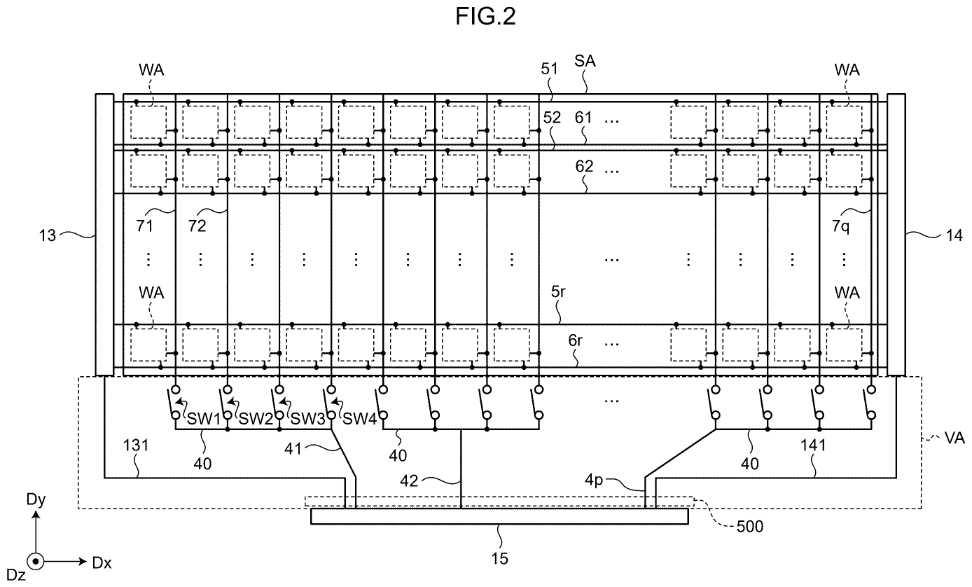

The sensor panel 10 is provided with a detection area SA (refer to FIG. 2) on a substrate 11. A reset circuit 13, a scan circuit 14, and a wiring area VA are mounted on the substrate 11. Components on the detection area SA, the reset circuit 13, and the scan circuit 14 are coupled to a detection circuit 15 via the wiring area VA.

The light source panel 20 has a light-emitting area LA that emits light to the detection area SA. The light source panel 20 is provided with a light source 22 on a substrate 21. Specifically, the light source 22 includes a light-emitting element such as a light-emitting diode (LED) and is located in the light-emitting area LA. In the example illustrated in FIG. 1, a plurality of the light sources 22 are arranged in a matrix having a row-column configuration on the substrate 21.

The light source panel 20 is provided with a light source drive circuit 23. Under the control of the control device 125, the light source drive circuit 23 controls turning on and off each of the light sources 22 and the luminance thereof when being turned on. The light sources 22 may be provided so as to allow individual control of light emission or may be provided so as to emit light collectively.

The control device 125 performs various processes related to operations of the detection device 1. Specifically, the control device 125 is a control device that includes a circuit, such as a field-programmable gate array (FPGA) or an application-specific integrated circuit (ASIC), that can implement a plurality of functions. The control device 125 may be replaced with a control circuit having the same functions. The control device 125 is coupled to the detection circuit 15 via flexible printed circuits (FPC) 19 and obtains an output from the detection circuit 15. The control device 125 is coupled to the light source drive circuit 23 via wiring 29 and performs processing related to the lighting of the light sources 22, such as determination of lighting patterns of the light sources 22.

The control device 125 also performs processing related to detection of colonies in an object to be detected SUB (refer to FIG. 5) to be described later.

Although not illustrated in the drawings, the detection device 1 includes an analog-to-digital conversion circuit, a digital-to-analog conversion circuit, and other components. The analog-to-digital conversion circuit allows an output from an optical sensor WA (refer to FIG. 2) transmitted through the detection circuit 15 to be handled by arithmetic processing by the control device 125. The digital-to-analog conversion circuit makes digital signals generated by the arithmetic processing of the control device 125 usable for controlling operations of the sensor panel 10 and the light source panel 20. These circuits may be included, for example, in part or in whole in the control device 125, may be functions performed by circuits mounted on the flexible printed circuits (FPC) provided as the FPC 19 and the wiring 29, or may be implemented in other ways in the detection device 1.

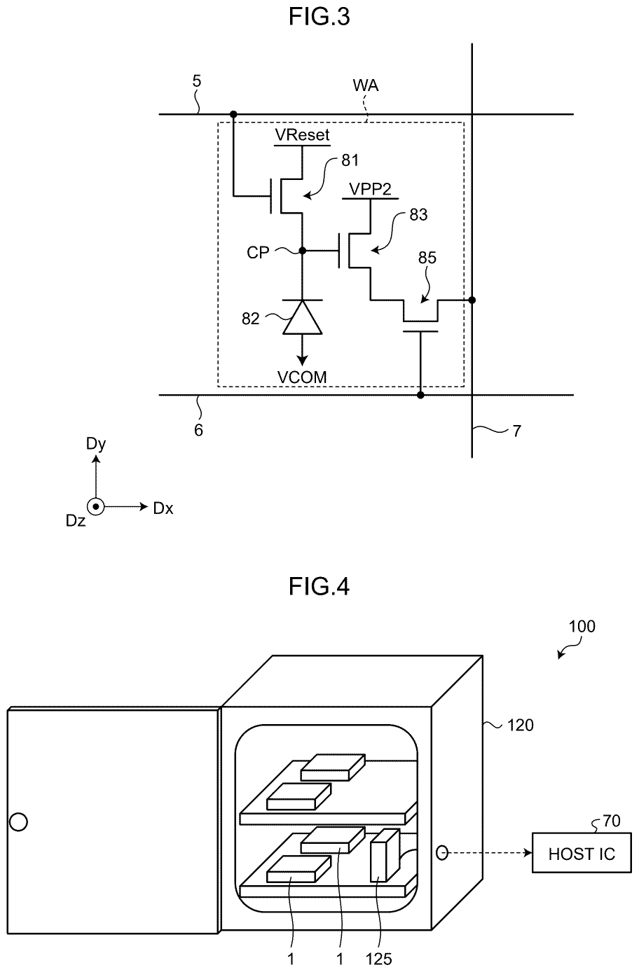

FIG. 2 is a diagram illustrating a configuration example of the detection area SA and the wiring area VA. A plurality of the optical sensors WA (FIG. 3) are provided in the detection area SA. In the embodiment, as illustrated in FIG. 2, the optical sensors WA are arranged in a matrix having a row-column configuration along a first direction Dx and a second direction Dy. The first direction Dx is orthogonal to the second direction Dy. In the following description, the term “third direction Dz” refers to a direction orthogonal to the first direction Dx and the second direction Dy.

The reset circuit 13 is coupled to reset signal transmission lines 51, 52, . . . , 5r. Hereinafter, the term “reset signal transmission line 5” refers to any one of the reset signal transmission lines 51, 52, . . . , 5r. The reset signal transmission line 5 is wiring along the first direction Dx. In the example illustrated in FIG. 2, r reset signal transmission lines 5 are arranged in the second direction Dy. The number “r” is a natural number equal to or larger than 2. The r reset signal transmission lines 5 are each coupled, at one end in the first direction Dx, to the reset circuit 13.

The scan circuit 14 is coupled to scan lines 61, 62, . . . , 6r. Hereinafter, the term “scan line 6” refers to any one of the scan lines 61, 62, . . . , 6r. The scan line 6 is wiring along the first direction Dx. In the example illustrated in FIG. 2, r scan lines 6 are arranged in the second direction Dy. The r scan lines 6 are each coupled, at the other end in the first direction Dx, to the scan circuit 14.

As illustrated in FIG. 2, the reset signal transmission lines 5 and the scan lines 6 are alternately arranged in the second direction Dy in the detection area SA. The reset circuit 13 and the scan circuit 14 illustrated in FIGS. 1 and 2 are arranged at locations facing each other with the detection area SA interposed therebetween, but the layout of the reset circuit 13 and the scan circuit 14 is not limited to this layout and can be changed as appropriate.

Signal lines 71, 72, . . . , 7q are also provided in the detection area SA. Hereinafter, the term “signal line 7” refers to any one of the signal lines 71, 72, . . . , 7q. The signal line 7 is wiring along the second direction Dy.

In the example illustrated in FIG. 2, q signal lines 7 are arranged in the first direction Dx. The number “q” is a natural number equal to or larger than 2. The q signal lines 7 are each coupled, at one end in the second direction Dy, to one of a plurality of switches (for example, a switch SW1, SW2, SW3, or SW4) included in multiplexers 40.

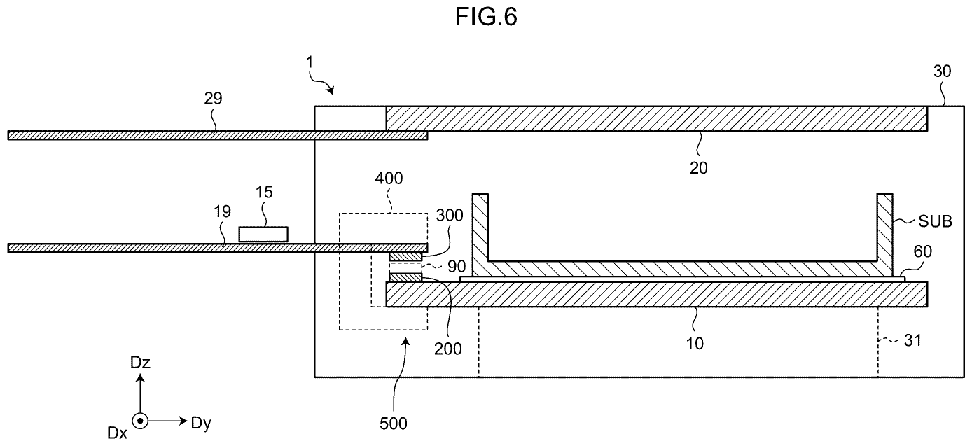

The multiplexers 40 are provided in the wiring area VA. The multiplexers 40 each include a plurality of switches. In the example illustrated in FIG. 2, the switches SW1, SW2, SW3, and SW4 are illustrated as the switches. The switches included in one multiplexer 40 are turned on (conducting state) at different times from one another. During a period when one of the switches included in one multiplexer 40 is on (conducting state), the other switches are off (non-conducting state). The number of the multiplexers 40 depends on the number (q) of the signal lines 7. When the number of the switches is p, q/p is sufficient as the number of the multiplexers 40. When more than one multiplexer 40 are provided, each of the multiplexers 40 is coupled to the detection circuit 15 via an individual one of wiring lines 41, 42, . . . , 4p. Electrical transmission paths between various types of wiring provided in the wiring area VA of the sensor panel 10 and the detection circuit 15 are provided via a terminal facing part 500 (refer to FIG. 6 and other figures). The terminal facing part 500 will be described later.

The coupling between the signal lines 7 and the detection circuit 15 via the multiplexer 40 is merely exemplary and is not limited to this example. The signal lines 7 may be individually directly coupled to the detection circuit 15 in the wiring area VA. In the wiring area VA, the reset circuit 13 is coupled to the detection circuit 15 via wiring 131. In the wiring area VA, the scan circuit 14 is coupled to the detection circuit 15 via wiring 141.

In detecting light using a PD 82 (refer to FIG. 3) provided in the optical sensor WA, the detection circuit 15 controls operation timing of the reset circuit 13 and the scan circuit 14. The detection circuit 15 receives an output from the optical sensor WA. The detection circuit 15 converts the signal received from the optical sensor WA into data that can be interpreted by the control device 125 and outputs the data to the control device 125. The detection circuit 15 of the embodiment is a microcontroller unit (MCU).

FIG. 3 is a circuit diagram illustrating a circuit configuration of the optical sensor WA. The first direction Dx and the second direction Dy in FIG. 3 merely correspond to the directions of the reset signal transmission lines 5, the scan lines 6, and the signal lines 7, and do not exactly indicate the relative positional relation of the circuit configuration in the optical sensor WA.

As illustrated in FIG. 3, a switching element 81, the PD 82, a transistor element 83, and a switching element 85 are provided in the optical sensor WA. The PD 82 is a photodiode (PD). The switching elements 81 and 85 and the transistor element 83 are metal-oxide semiconductor field-effect transistors (MOSFETs).

The gate of the switching element 81 is coupled to the reset signal transmission line 5. One of the source and the drain of the switching element 81 is provided with a reset potential VReset. The other of the source and the drain of the switching element 81 is coupled to the cathode of the PD 82 and the gate of the transistor element 83. Hereinafter, the term “coupling part CP” refers to a point where the other of the source and the drain of the switching element 81 is coupled to the cathode of the PD 82 and the gate of the transistor element 83. A reference potential VCOM is provided from the anode side of the PD 82. The potential difference between the reset potential VReset and the reference potential VCOM is set in advance, but the reset potential VReset and the reference potential VCOM may be variable. The reset potential VReset is higher than the reference potential VCOM.

The drain of the transistor element 83 serving as a source follower is provided with an output source potential VPP2. The source of the transistor element 83 is coupled to one of the source and the drain of the switching element 85. The other of the source and the drain of the switching element 85 is coupled to the signal line 7. The gate of the switching element 85 is coupled to the scan line 6.

The reset potential VReset, the reference potential VCOM, and the output source potential VPP2 are generated based on, for example, power supplied via a power supply circuit to be described later, but are not limited to being generated in this way, and may be generated in a different way as appropriate.

The output source potential VPP2 is set in advance. The potential on the source side of the transistor element 83 is a potential lower than the output potential of the PD 82 by a voltage (Vth) between the gate and the source of the transistor element 83. In this case, the potential on the source side of the transistor element 83 corresponds to the reset potential VReset and the reference potential VCOM. The potential of the output of the PD 82 corresponds to photovoltaic power that is generated by the PD 82 according to the light detected by the PD 82 during an exposure period.

When the gate of the switching element 85 is turned on by a signal given from the scan circuit 14 via the scan line 6, the source and the drain of the switching element 85 are brought into a conducting state therebetween. As a result, a signal (potential) transmitted via the transistor element 83 to the switching element 85 is transmitted to the signal line 7 via the switching element 85. Thus, the output from the optical sensor WA is generated. Hereinafter, the term “scan signal” refers to the signal (potential) given from the scan circuit 14 via the scan line 6. The scan circuit 14 is a circuit that outputs the scan signal.

The output of one PD 82 provided in one optical sensor WA corresponds to the intensity of the light detected by the PD 82 during the exposure period set in advance. The output of the PD 82 is reset in response to a signal provided by the reset circuit 13 via the reset signal transmission line 5. When the signal turns on the gate of the switching element 81, the source and the drain of the switching element 81 are brought into a conducting state therebetween. This operation resets the potential of the coupling part CP to the reset potential VReset.

FIG. 4 is a schematic diagram schematically illustrating a configuration example of a detection system 100 including the detection device 1. As illustrated in FIG. 4, the detection system 100 includes a plurality of the detection devices 1, a host integrated circuit (IC) 70, and the control device 125. The detection devices 1 are electrically coupled to the common host IC 70 via the control device 125.

An incubator 120 illustrated in FIG. 4 is maintained such that an environment (temperature, humidity, and the like) therein is suitable for culturing the colonies on the object to be detected SUB while a door is closed. The detection devices 1 are placed in the incubator 120. The object to be detected SUB is provided with a culture medium (e.g., agar) in which the colonies can be cultured.

FIG. 5 is a schematic diagram illustrating a relation between one of the detection devices 1 and an external configuration. As illustrated in FIG. 5, the detection device 1 is coupled to the control device 125 by coupling a case 30 to the control device 125. As illustrated in FIG. 5, the sensor panel 10 faces the light source panel 20. A gap where the object to be detected SUB can be located is provided between the sensor panel 10 and the light source panel 20. The gap is formed by supporting the sensor panel 10 and the light source panel 20 with the case 30.

The object to be detected SUB is made of a light-transmitting material and has the culture medium formed on the upper surface thereof. The culture medium is a culture medium capable of culturing the colonies. The term simply called “colonies” refers to colonies formed by biological tissues or microorganisms cultured in the culture medium formed on the object to be detected SUB. More specifically, the object to be detected SUB is, for example, a glass Petri dish, but is not limited thereto, and may have another configuration that functions in the same way. The culture medium formed on the object to be detected SUB does not have a totally light-blocking property and has such a degree of light-transmitting property that the degree of light transmission varies depending on the presence or absence of the colonies and the thickness of the colonies.

FIG. 6 is a schematic view illustrating a configuration inside the case 30 and a relation between the sensor panel 10 and the FPC 19. When the object to be detected SUB is placed between the sensor panel 10 and the light source panel 20, the object to be detected SUB is placed on a member 60 as illustrated in FIG. 6. The member 60 is configured to allow the object to be detected SUB to be placed thereon so that the object to be detected SUB is interposed between the detection area SA and the light source panel 20.

In the embodiment, the sensor panel 10 is located below the object to be detected SUB and the light source panel 20 is located above the object to be detected. The member 60 of the embodiment also serves as an optical member that limits the light that is emitted from the light source 22 of the light source panel 20 and reaches the sensor panel 10. Specifically, the member 60 includes any of a plate-shaped louver, cylindrical openings, and microlenses. In the plate-shaped louver, a plurality of plate-like structures, which have plate surfaces extending along the third direction Dz, are arranged in parallel. The structures are preferably made of a material having a strong light-absorbing property. The cylindrical openings are cylindrical openings that penetrate the member 60, which extends along a plane (Dx-Dy plane) orthogonal to the third direction Dz, in the third direction Dz with respect to the base of the member 60. The base is preferably made of a material having a strong light-absorbing property. The microlenses are each a small lens having an optical axis along the third direction Dz. The base of the member 60 that supports the microlenses is preferably made of a material having a strong light-absorbing property. The member 60 as the optical member is provided in order to limit the traveling direction of the light emitted from the light source 22 and reaching the sensor panel 10 to the third direction Dz or a direction having a shallower inclination angle with respect to the third direction Dz. The member 60 only needs to be a member that exhibits light transmittance that allows the sensor panel 10 to detect changes in degree of light transmittance corresponding to the presence or absence of the colonies and the thickness of the colonies on the object to be detected SUB, and need not be an optical member that limits light reaching the sensor panel 10.

As illustrated in FIG. 6, the detection circuit 15 is provided on the FPC 19. The FPC 19 is an FPC, that is, a flexible substrate. Thus, the detection device 1 includes the FPC 19 provided with wiring that transmits signals to be transmitted between the sensor panel 10 and the detection circuit 15 provided outside the sensor panel 10.

As illustrated in FIG. 6, the sensor panel 10 and the FPC 19 are provided so that a first terminal 200 of the sensor panel 10 faces a second terminal 300 of the FPC 19. The first terminal 200 is not in contact with the second terminal 300. In the configuration illustrated in FIG. 6, in a state where an insulating layer 90 is interposed between the first terminal 200 and the second terminal 300, a positional relation among the first terminal 200, the insulating layer 90, and the second terminal 300 is held by a gripping member 400.

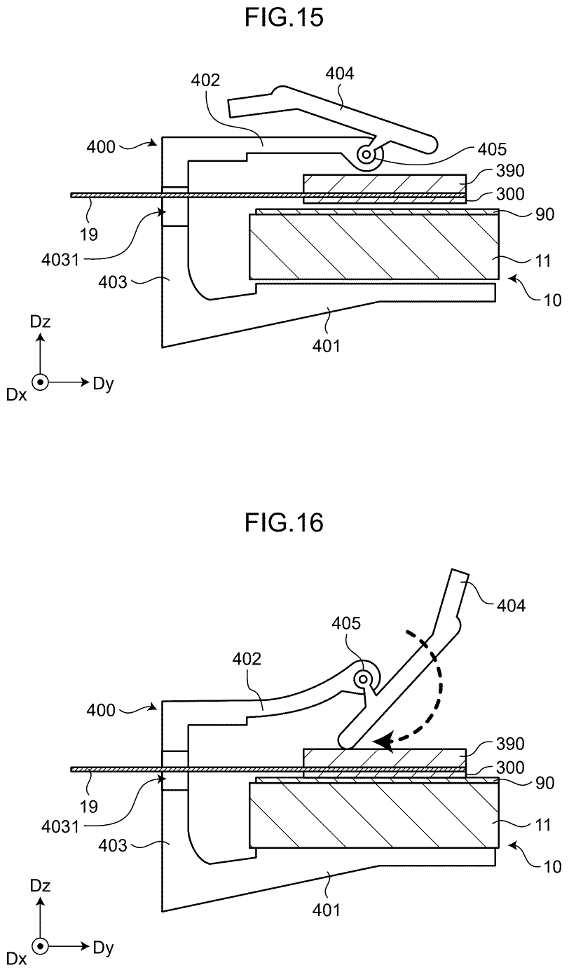

More specifically, the gripping member 400 is provided on a side of the sensor panel 10 from which the FPC 19 extends. The gripping member 400 has a hole 4031 (refer to FIG. 15 and other figures) in which the FPC 19 can be inserted.

In the configuration illustrated in FIG. 6, the sensor panel 10 is placed on a placement part 31 in the case 30. The placement part 31 is designed for providing a space for the gripping member 400 to extend toward the opposite side of the sensor panel 10 to the first terminal 200 side of the sensor panel 10.

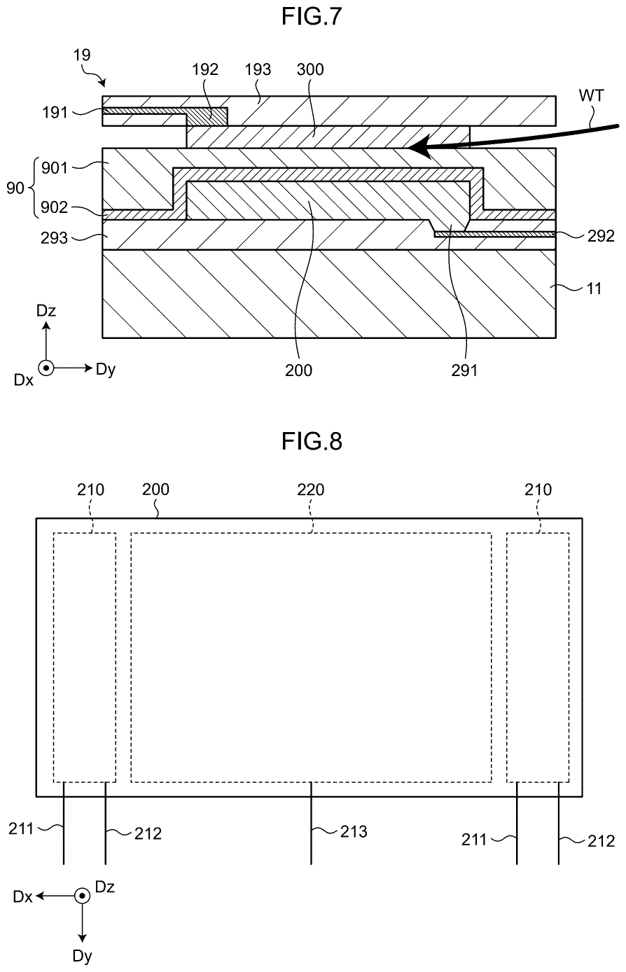

FIG. 7 is a sectional view illustrating a specific example of the first terminal 200, the insulating layer 90, the second terminal 300, and a configuration around these components. The first terminal 200 is a conductive terminal formed on the sensor panel 10. More specifically, the sensor panel 10 includes a wiring line 292 formed on one surface of the substrate 11. The wiring line 292 is wiring coupled to the detection circuit 15 in FIG. 2. That is, the wiring line 292 is one of the wiring lines 41, 42, . . . , 4p, 131, 141. A most part of the wiring line 292 on the one surface side is covered by an insulating layer 293. The insulating layer 293 is provided with a contact portion 291 to expose a portion of the wiring line 292 on the one surface side. A material included in the first terminal 200 is stacked in an area overlapping the contact portion 291 in plan view, thereby coupling the first terminal 200 to the wiring line 292. The first terminal 200 is formed using, for example, aluminum or molybdenum-tungsten alloy (MoW), but may be formed of other conductors.

The insulating layer 90 includes, for example, a first insulating layer 901 and a second insulating layer 902, as illustrated in FIG. 7. The second insulating layer 902 is an inorganic passivation film that covers the one surface of the substrate 11 and one surface of the first terminal 200. The first insulating layer 901 is a planarizing film covering one surface of the second insulating layer 902. The first insulating layer 901 fills a step between the first terminal 200 and the substrate 11 to planarize one surface of the sensor panel 10. The first insulating layer 901 and the second insulating layer 902 each serve as an insulator. Thus, the first terminal 200, which is a conductor coupled to the wiring line 292 provided in the sensor panel 10, is covered by the insulating layer 90.

The second terminal 300 is a conductive terminal formed on the FPC 19. More specifically, the FPC 19 is a component, such as an FPC, provided with a wiring line 191 covered by an insulator 193. A contact portion 192 of the wiring line 191 is exposed outside the insulator 193 so that the wiring line 191 is coupled to the second terminal 300. The second terminal 300 is formed using copper, for example, but may be formed using other conductors. The second terminal 300 is provided correspondingly to the first terminal 200, as illustrated in FIGS. 8 to 12 to be explained later. As illustrated in FIG. 7, the second terminal 300 is a conductor coupled to the wiring line 191 and faces the first terminal 200 with the insulating layer 90 interposed therebetween. The second terminal 300 and the first terminal 200, facing each other with the insulating layer 90 interposed therebetween, are in a non-conducting state.

The FPC 19 of the embodiment includes the wiring line 191 and another wiring portion. The wiring line 191 serves as wiring that couples the second terminal 300 to the detection circuit 15. The other wiring portion serves as wiring that couples the detection circuit 15 to the control device 125. The wiring line 191 and the other wiring portion may be provided by separate configurations.

The first terminal 200 and the second terminal 300 are provided to transmit power and signals. The configuration for the transmission of the power and signals will be described with reference to FIGS. 8 to 12.

FIG. 8 is a schematic view illustrating a configuration of the first terminal 200. The first terminal 200 includes a coil 210 and a terminal 220.

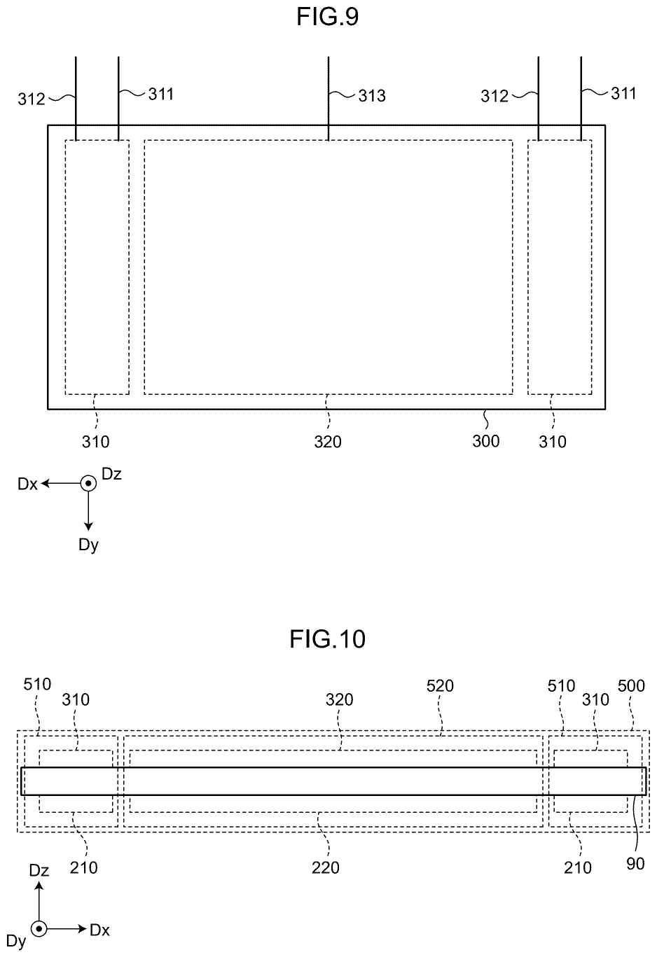

FIG. 9 is a schematic view illustrating a configuration of the second terminal 300. The second terminal 300 includes a coil 310 and a terminal 320.

FIG. 10 is a schematic view illustrating a facing relation between the coil 210 and the coil 310 and a facing relation between the terminal 220 and the terminal 320. The coil 210 faces the coil 310 with the insulating layer 90 interposed therebetween. The coils 210 and 310 constitute a power transmitter 510. The terminal 220 faces the terminal 320 with the insulating layer 90 interposed therebetween. The terminals 220 and 320 constitute a signal transmitter 520.

In FIGS. 8, 9, and 10, two coils 210 are arranged so as to face each other with the terminal 220 interposed therebetween, and two coils 310 are arranged so as to face each other with the terminal 320 interposed therebetween. However, the number of the coils 210 and the number of the coils 310 are not limited to two, and may each be one.

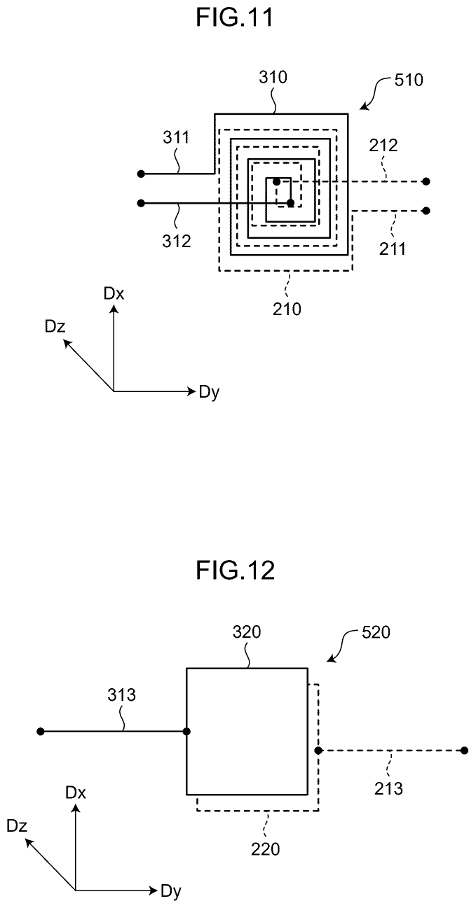

FIG. 11 is a schematic view illustrating the coil 210 and the coil 310 of the power transmitter 510. The coil 210 is a coil provided in the first terminal 200. The coil 310 is a coil provided in the second terminal 300. As illustrated in FIG. 11, one end of a winding of the coil 310 is continuous with a power line 311. The other end of the winding of the coil 310 is continuous with a power line 312. One of the power lines 311 and 312 is coupled to the positive side of a power supply. The other of the power lines 311 and 312 is coupled to the negative side of the power supply.

The coil 310 is supplied with power from the power supply coupled to the power lines 311 and 312. A current caused by the power supplied to the coil 310 generates a magnetic field around the coil 310. The magnetic field generates a current caused by electromagnetic induction through the coil 210 facing the coil 310. Thus, the coils 310 and 210 are arranged so as to face each other in order to generate the current through the coil 210 by supplying the power to the coil 310. That is, the power is transmitted from the coil 310 to the coil 210 in the non-contact positional relation between the first terminal 200 including the coil 210 and the second terminal 300 including the coil 310. Thus, the first and the second terminals 200 and 300 constitute the power transmitter 510 that includes the coils 210 and 310 that transmit the power through the electromagnetic induction.

The various components provided on the sensor panel 10 are operated by the current generated through the coil 210. As illustrated in FIG. 11, one end of a winding of the coil 210 is continuous with a power line 211. The other end of the winding of the coil 210 is continuous with a power line 212. One of the power lines 211 and 212 is coupled to the anode sides of the various components provided on the sensor panel 10. The other of the power lines 211 and 212 is coupled to the cathode sides of the various components provided on the sensor panel 10.

More specifically, the power lines 211 and 212 need not be directly coupled to the various components provided on the sensor panel 10. For example, the current flowing from the coil 210 is given to a power supply circuit included in the detection circuit 15. The power supply circuit individually supplies power to the various components provided on the sensor panel 10 at voltages that are suitable for the respective various components, such as the reset circuit 13 and the scan circuit 14.

The power lines 211 and 212 and a signal transmission line 213 are provided as the individual wiring lines 292 (refer to FIG. 7). The power lines 311 and 312, and a signal transmission line 313 are provided as the individual wiring lines 191 (refer to FIG. 7).

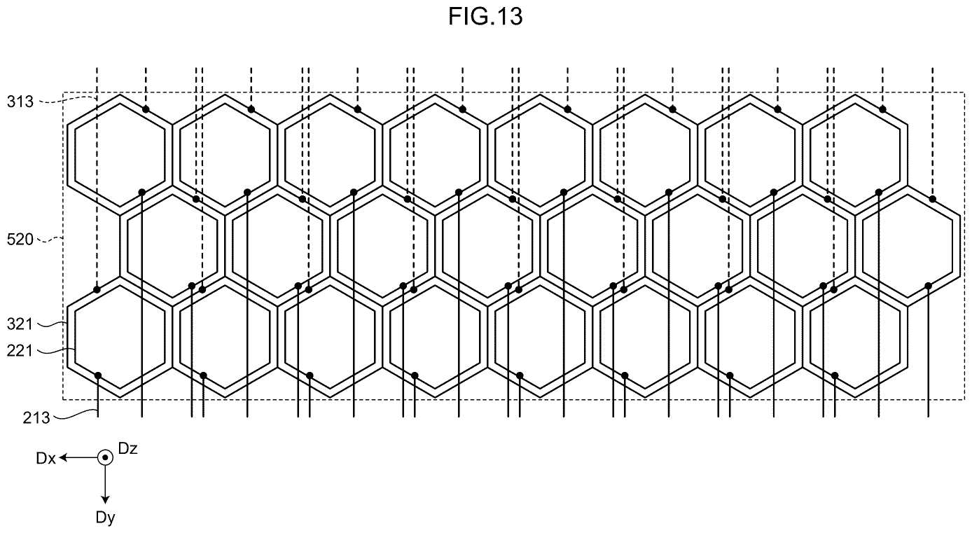

FIG. 12 is a schematic conceptual diagram illustrating a basic relation between the terminals 220 and 320 of the signal transmitter 520. The terminals 220 and 320 each include an electrode along the Dx-Dy plane. The terminals 220 and 320 face each other in the third direction Dz. This configuration generates electrostatic capacitance between the terminals 220 and 320.

The terminal 220 is coupled to the signal transmission line 213. The terminal 320 is coupled to the signal transmission line 313. The signal transmission line 213 is coupled to a signal output terminal of the detection circuit 15. The signal output terminal is a terminal from which a signal (output signal) indicating the intensity of the light detected by the optical sensor WA is output. That is, the potential of the terminal 220 can change depending on the intensity of the light detected by the optical sensor WA. When the potential of the terminal 220 changes, the potential of the terminal 320, which is located on the opposite side to the terminal 220 and forms a capacitive element with the terminal 220, changes in the same direction as that of the terminal 220 due to an effect of capacitive coupling. The change in the potential of the terminal 320 is transmitted via the signal transmission line 313 to a configuration coupled to the terminal 320. In the embodiment, the signal transmission line 313 is coupled to the control device 125 (refer to FIGS. 4 and 5). Thus, the output from the optical sensor WA included in the sensor panel 10 results in a change in potential of the terminal 320 due to the effect of the capacitive coupling between the terminals 220 and 320. As a result, even when the terminal 220 is not in contact with the terminal 320, the electrical change corresponding to the output signal can be generated on the terminal 320 side. That is, the terminals 220 and 320 are arranged so as to face each other in order to transmit the output signal in a non-contact manner. Thus, the first and the second terminals 200 and 300 constitute the signal transmitter 520 that transmits signals through the electrostatic capacitance between the conductors (terminals 220 and 320) facing each other. The facing distance between the first and the second terminals 200 and 300 that face each other with a component serving as an insulator, such as the insulating layer 90, interposed therebetween is a distance enough to be able to generate the electromagnetic induction in the power transmitter 510 and the electrostatic capacitance in the signal transmitter 520. Specifically, for example, to reduce mixing of the transmitted signals between the adjacent terminals, the facing distance is preferably smaller than distances between respective terminals of the terminal 220 or distances between respective terminals of the terminal 320. However, the facing distance is not limited to such a distance and may be changed as appropriate.

A rectifier such as a diode may be provided for the purpose of more reliably supplying the power from the coil 310 to the coil 210 and transmitting the output signals from the terminal 220 to the terminal 320.

The transmission of the signals using the electrostatic capacitance while the terminals 220 and 320 are arranged so as to face each other is not limited to the transmission of the output signals, and may be used to transmit various types of signals. Examples of the various signals include, but are not limited to, signals for control that are given from the control device 125 to the reset circuit 13 and the scan circuit 14. Hereinafter, the term “output signals and the like” refers to any signals transmitted using the terminals 220 and 320, including the output signals and such various signals.

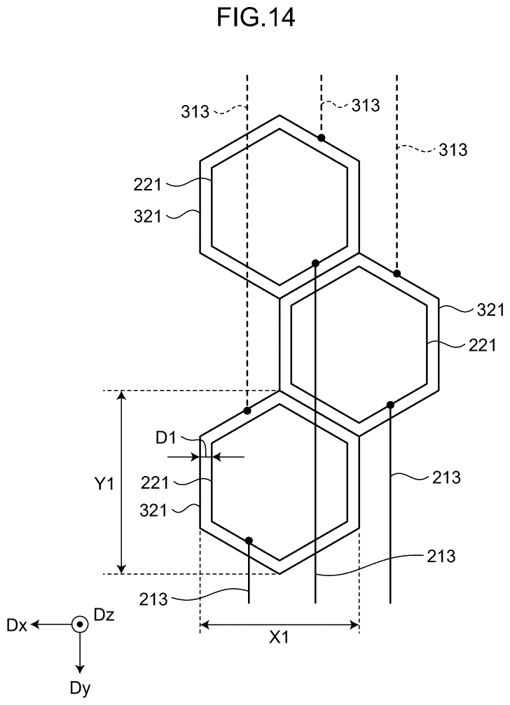

FIG. 12 is merely a schematic conceptual diagram for illustrating the arrangement of the terminals 220 and 320 facing each other. The following describes an example of a more specific configuration provided in the signal transmitter 520 (refer to FIG. 10) in which the terminals 220 and 320 overlap each other in plan view, with reference to FIGS. 13 and 14.

FIG. 13 is a view illustrating the example of the more specific configuration provided in the signal transmitter 520. As illustrated in FIG. 13, the signal transmitter 520 is provided with a plurality of terminals 221 and a plurality of terminals 321. The terminals 221 and 321 are hexagonal in shape in plan view. The terminals 221 serve as the terminals 220. The terminals 321 serve as the terminals 320. That is, the terminals 221 and 321 overlap each other in plan view and face each other while being separated in the third direction Dz. The terminals 221 and 321 are provided so as to generate electrostatic capacitance therebetween, and thus, to be capable of transmitting the output signals and the like in a non-contact manner.

FIG. 14 selectively illustrates three of the terminals 221 and three of the terminals 321 illustrated in FIG. 13. As illustrated in FIG. 14, each of the terminals 221 is coupled to the individual signal transmission line 213. Each of the terminals 321 is coupled to the individual signal transmission line 313. That is, a plurality of the signal transmission lines 213 and a plurality of the signal transmission lines 313 are provided. When one of the terminals 221 and one of the terminals 321 that overlap in plan view are assumed as a pair of terminals, the signal transmitter 520 is provided with a plurality of pairs of the terminals. Each of the pairs of the terminals is provided so as to individually generate electrostatic capacitance and to be capable of individually transmitting the output signals and the like. To explain the correspondence relation between FIGS. 13 and 14, the configuration illustrated in FIG. 13 can be said to be an arrangement obtained by arranging a plurality of the configurations illustrated in FIG. 14 in the first direction Dx.

The area of the terminal 221 provided in the signal transmitter 520 of the first terminal 200 differs from the area of the terminal 321 provided in the signal transmitter 520 of the second terminal 300. Specifically, the terminal 321 is larger than the terminal 221, as illustrated in FIGS. 13 and 14. Specifically, the terminal 321 is large enough to rim the terminal 221 by a width D1 illustrated in FIG. 14 when the terminals 221 and 321 overlap each other in an ideal positional relation in plan view. The term “overlap each other in an ideal positional relation” means that the center of the terminal 221 in plan view matches the center of the terminal 321 in plan view, in a positional relation in plan view.

In FIGS. 13 and 14, the terminals 321 are laid out as if two of the terminals 321 closer to each other share one of the outer edges of the hexagonal shape in plan view, but, in reality, the terminals 321 are provided so as not to be in contact with each other. Specifically, a honeycomb-like continuous non-contact area in plan view is formed in the signal transmitter 520. The terminals 321 are arranged in a staggered manner in the signal transmitter 520 while being separated from one another by the non-contact area, as illustrated in FIG. 13. The terminals 221 are arranged in a staggered manner so as to overlap the terminals 321 in the signal transmitter 520.

The terminals 221 and 321 illustrated in FIGS. 13 and 14 are regular hexagonal in shape in plan view. In the terminals 221 and 321, two of the six sides forming the outer edges of the regular hexagonal shape face each other in the first direction Dx and extend along the second direction Dy. The terminals 321 are provided such that the width in the first direction Dx between the two sides is a width X1. The terminals 321 are provided also such that the width between two vertices facing each other in the second direction Dy is a width Y1. The width Y1 is larger than the width X1.

To take a more specific example, the width X1 is 3.22 millimeters (mm) and the width Y1 is 3.72 mm, but the dimensions of the terminal 321 are not limited to this example, and can be changed as appropriate. The width D1 is 0.2 mm, but the relation in size between the terminals 321 and 221 is not limited to this example, and can be changed as appropriate.

In the embodiment, as illustrated in FIG. 13, the wiring pattern is provided in advance such that the signal transmission lines 213 do not touch one another, and the signal transmission lines 313 do not touch one another.

The following describes an example of a more specific form of the gripping member 400 with reference to FIGS. 15 to 17.

FIG. 15 is a view illustrating an example of the gripping member 400. As illustrated in FIG. 15, the gripping member 400 includes a first extension 401, a second extension 402, a base 403, and a movable portion 404.

The first extension 401, the second extension 402, and the base 403 are formed as one continuous member. The first and the second extensions 401 and 402 are continuous through the base 403 on one side in the second direction Dy where the FPC 19 extends. The first and the second extensions 401 and 402 extend from the base 403 toward the other side in the second direction Dy, and face each other in the third direction Dz in a positional relation with the sensor panel 10, the second terminal 300, and other components interposed therebetween.

In FIGS. 15 to 17, a flat plate portion 390 is provided on the second extension 402 side of the second terminal 300. The flat plate portion 390 is a flat plate-shaped member for allowing the first and the second terminals 200 and 300 to more stably receive a gripping force from the gripping member 400. Since the flat plate portion 390 is provided, the first and the second terminals 200 and 300 can more stably receive the gripping force from the gripping member 400, even when the FPC 19 is a flexible member such as an FPC. The flat plate portion 390 is not an essential component and may be omitted as illustrated in FIG. 6 and other figures.

The base 403 is the portion of the gripping member 400 that extends along a Dx-Dz plane. The base 403 has a hole 4031 provided so as to allow the FPC 19 to be inserted therein.

The second extension 402 rotatably supports, on the extending end side thereof, the movable portion 404. The movable portion 404 is a member that is rotatably provided about a shaft 405 on the extending end side of the second extension 402. The shaft 405 is provided so as to be switchable, by switching of the rotational angle, between a first rotational angle position and a second rotational angle position, wherein the first rotational angle position is a rotational angle position of entering between the first and the second extensions 401 and 402, and the second rotational angle position is a rotational angle position of wrapping around to the opposite side to the first extension 401 with respect to the second extension 402. The movable portion 404 illustrated in FIG. 15 is at the rotational angle position of wrapping around to the opposite side to the first extension 401 with respect to the second extension 402.

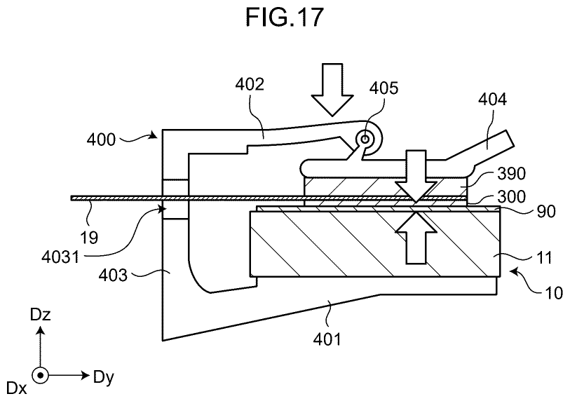

FIG. 16 is a view illustrating the rotation of the movable portion 404 illustrated in FIG. 15. FIG. 17 is a view illustrating the gripping member 400 after completion of the rotation of the movable portion 404 illustrated in FIG. 16. When an operation of switching the rotation angle so that the movable portion 404 enters between the first and the second extensions 401 and 402 is completed as illustrated in FIG. 16, the distance between the first and the second extensions 401 and 402 becomes smaller by an amount by which the movable portion 404 has entered, as illustrated in FIG. 17. As a result, the first extension 401 contacts the sensor panel 10 and the second extension 402 contacts the flat plate portion 390 via the movable portion 404. The first and the second extensions 401 and 402 are continuous through the base 403. Thus, the gripping member 400 generates the gripping force that brings the first terminal 200 (refer to FIG. 7) in the insulating layer 90 formed on the one surface side of the sensor panel 10 and the second terminal 300 formed on the FPC 19 into pressure contact. As a result, the facing positional relation between the first and the second terminals 200 and 300 with the insulating layer 90 interposed therebetween is stably established as described with reference to FIG. 6.

The second extension 402 is preferably so flexible as to be deformable to allow the distance between the first and the second extensions 401 and 402 to be increased so that the movable portion 404 can more smoothly enter between the first and the second extensions 401 and 402.

As illustrated in FIG. 7, in the embodiment, the first terminal 200 is covered by the insulating layer 90. In the embodiment, as described with reference to FIGS. 8 to 14, the first and the second terminals 200 and 300 are provided so as to be capable of transmitting the power, the output signals, and the like in the non-contact facing positional relation. With these configurations, in the embodiment, as illustrated in FIG. 7, even if a metal corrosive component WT such as moisture or the like enters between the first and the second terminals 200 and 300, the terminal 200 that is susceptible to damage by corrosion is protected from the corrosive component by the insulating layer 90. Therefore, no substantial problems arise in the transmission of the power, the output signals, and the like between the first and the second terminals 200 and 300.

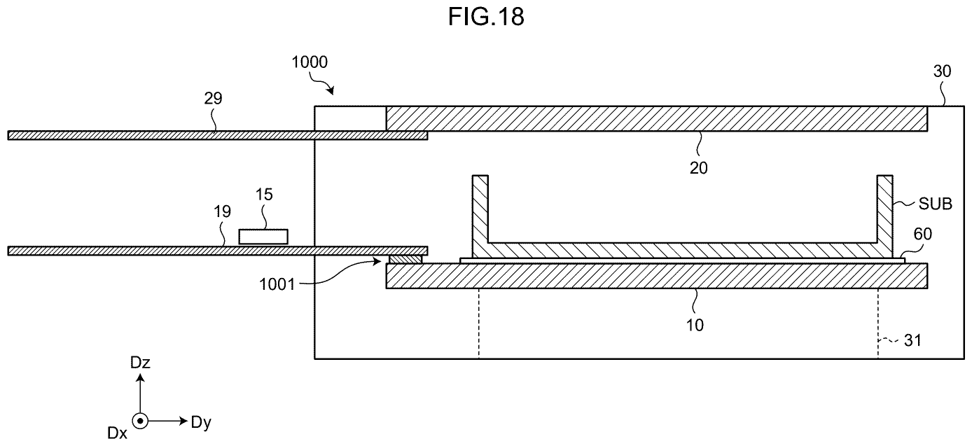

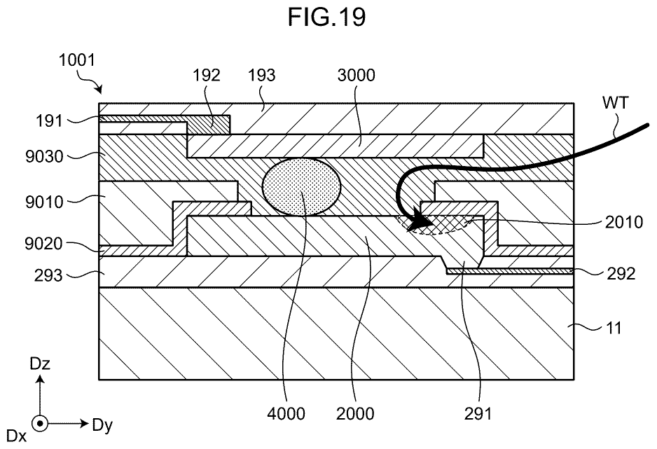

FIG. 18 is a schematic view illustrating a reference example in which the sensor panel 10 is physically directly coupled to the FPC 19 via a coupling member 1001. FIG. 19 is a view illustrating a specific configuration of the coupling member 1001 illustrated in FIG. 18 and degradation of the coupling member 1001 by the optical sensor WA.

As illustrated in FIG. 18, in the reference example, the sensor panel 10 is coupled to the FPC 19 via the coupling member 1001. More specifically, in the coupling member 1001, a first terminal 2000 is coupled to a second terminal 3000 via anisotropic conductive adhesive tape 9030 containing conductive particles 4000, as illustrated in FIG. 19. The first terminal 2000 in the reference example is the same as the first terminal 200 in the embodiment. The second terminal 3000 in the reference example is the same as the second terminal 300 in the embodiment. In the reference example, an opening to expose one surface of the first terminal 2000 is provided in a first insulating layer 9010 and a second insulating layer 9020 in order to physically contact the conductive particles 4000 to the first terminal 2000. The first insulating layer 9010 of the reference example has the same configuration as the first insulating layer 901 of the embodiment, except that the opening is formed. The second insulating layer 9020 of the reference example has the same configuration as the second insulating layer 902 of the embodiment, except that the opening is formed. A portion of the opening formed in the first insulating layer 9010 and the second insulating layer 9020 that is not occupied by the conductive particles 4000 is filled with the anisotropic conductive adhesive tape 9030.

In the reference example, if the metal corrosive component WT such as moisture or the like enters between the first terminal 2000 and the second terminal 3000, the metal corrosive component WT reaches the first terminal 2000 through the anisotropic conductive adhesive tape 9030. The metal corrosive component WT such as moisture or the like that has reached the first terminal 2000 causes corrosion 2010. In FIG. 19, the corrosion 2010 has not progressed to disconnect the connection between the first terminal 2000 and the contact portion 291, but, in the reference example, the corrosion 2010 may expand to disconnect the connection between the first terminal 2000 and the contact portion 291. Thus, in the reference example, the conduction path between the wiring line 292 and the wiring line 191 may be damaged.

In contrast, according to the embodiment, the transmission of the power, the output signals, and the like is performed by the configuration in which the first terminal 200 faces the second terminal 300 in a non-contact manner. As a result, the first terminal 200 is fully covered without forming an opening such as that provided in the first insulating layer 9010 and the second insulating layer 9020 in the reference example. Therefore, corrosion such as the corrosion 2010 in the reference example is inhibited on the first terminal 200. Thus, the electrical transmission path between the sensor panel 10 and the wiring of the FPC 19 is less likely to deteriorate due to corrosion.

### Modifications

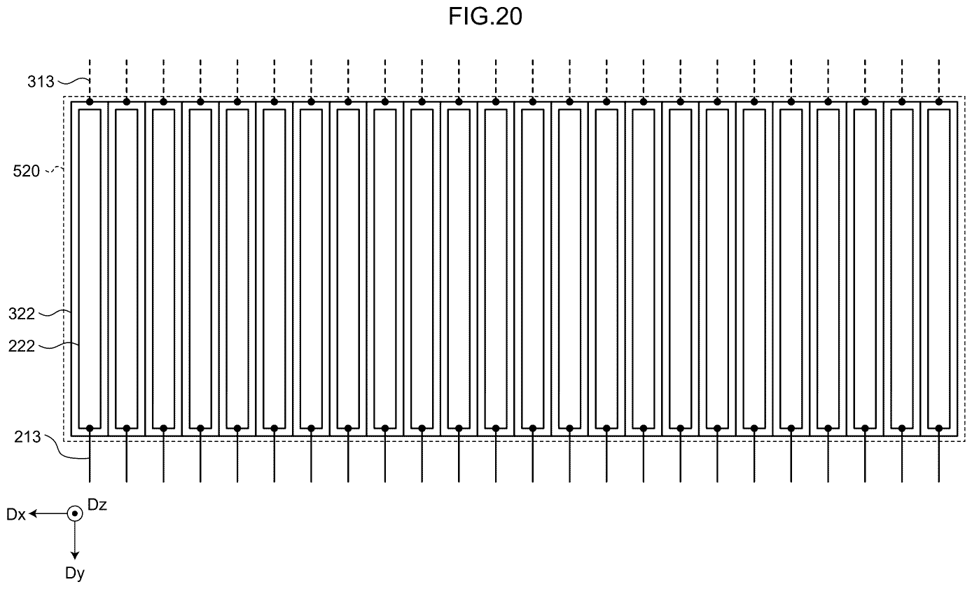

The following describes modifications of the embodiment with reference to FIGS. 20 to 26. In the description of the modifications, the same components as those in the embodiment are denoted by the same reference numerals, and will not be described again.

### First Modification

FIG. 20 is a view illustrating an example of a specific configuration provided in the signal transmitter 520 in a modification of the embodiment. As illustrated in FIG. 20, in a first modification, a plurality of terminals 222 and a plurality of terminals 322 are provided in the signal transmitter 520. The terminals 222 and 322 are rectangular in shape in plan view. The terminals 222 serve as the terminals 220. The terminals 322 serve as the terminals 320. That is, the terminals 222 and 322 overlap each other in plan view and face each other while being separated in the third direction Dz. The terminals 222 and 322 are provided so as to generate electrostatic capacitance therebetween, and thus, to be capable of transmitting the output signals and the like in a non-contact manner.

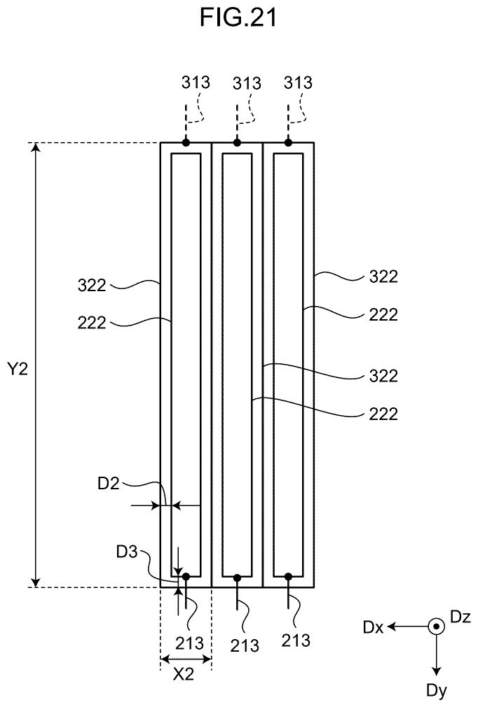

FIG. 21 selectively illustrates three of the terminals 222 and three of the terminals 322 illustrated in FIG. 20. As illustrated in FIG. 21, each of the terminals 222 is coupled to the individual signal transmission line 213. Each of the terminals 322 is coupled to the individual signal transmission line 313.

In the terminals 222 and 322, two facing sides of the four sides forming the outer edges of the rectangular shape extend along the second direction Dy, and the other two sides extend along the first direction Dx. The terminals 222 and 322 are rectangular terminals that are longer in the second direction Dy than in the first direction Dx. As illustrated in FIG. 21, each of the terminal 322 has a width X2 in the first direction Dx and a width Y2 in the second direction Dy.

The area of the terminal 222 provided in the signal transmitter 520 of the first terminal 200 differs from the area of the terminal 322 provided in the signal transmitter 520 of the second terminal 300. Specifically, the terminal 322 is larger than the terminal 222, as illustrated in FIGS. 20 and 21. Specifically, the terminal 322 is large enough to rim the terminal 222 by a width D2 in the first direction Dx and rim the terminal 222 by a width D3 in the second direction Dy when the terminals 222 and 322 overlap each other in the ideal positional relation in plan view.

To take a more specific example, the width X2 is 1 mm and the width Y2 is 9 mm, but the dimensions of the terminal 322 are not limited to this example, and can be changed as appropriate. The widths D2 and D3 are each 0.2 mm, but the relation in size between the terminals 322 and 222 is not limited to this example, and can be changed as appropriate.

In FIGS. 20 and 21, the terminals 322 are laid out as if two of the terminals 322 closer to each other share one of the outer edges of the rectangular shape in plan view, but, in practice, the terminals 322 are provided so as not to be in contact with each other. Specifically, a non-contact area as a gap along the second direction Dy in plan view is formed in the signal transmitter 520 between two adjacent terminals 322 in the first direction Dx. As described above, the first modification is the same as the embodiment except that the terminals 221 and 321 are replaced with the terminals 222 and 322 in the configuration provided in the signal transmitter 520.

In the example illustrated in FIG. 20, the rectangular terminals that are longer in the second direction Dy than in the first direction Dx are provided in the signal transmitter 520, but the relative relation between the width in the first direction Dx and the width in the second direction Dy of the rectangular terminals is not limited to this example.

### Second Modification

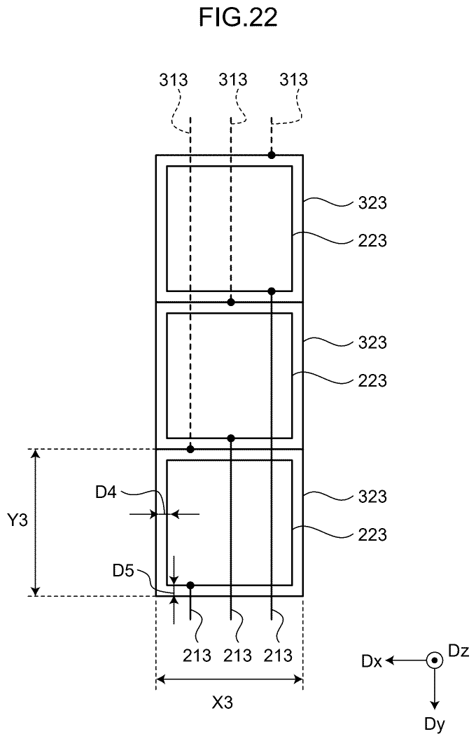

FIG. 22 is a view illustrating rectangular terminals 223 and 323 that differ from the terminals 222 and 322 illustrated in FIG. 21 in the relative relation between the width in the first direction Dx and the width in the second direction Dy. In a second modification of the embodiment, a plurality of the terminals 223 and a plurality of the terminals 323 are provided in the signal transmitter 520. The terminals 223 serve as the terminals 220. The terminals 323 serve as the terminals 320. That is, the terminals 223 and 323 overlap each other in plan view and face each other while being separated in the third direction Dz. The terminals 223 and 323 are provided so as to generate electrostatic capacitance therebetween, and thus, to be capable of transmitting the output signals and the like in a non-contact manner. The terminal 323 has a width X3 in the first direction Dx and a width Y3 in the second direction Dy. The width X3 equals the width Y3. That is, the terminals 323 are square in shape.

The area of each of the terminals 223 provided in the signal transmitter 520 of the first terminal 200 differs from the area of each of the terminals 323 provided in the signal transmitter 520 of the second terminal 300. Specifically, as illustrated in FIG. 22, the terminal 323 is larger than the terminal 223. Specifically, the terminal 323 is large enough to rim the terminal 223 by a width D4 in the first direction Dx and rim the terminal 223 by a width D5 in the second direction Dy when the terminals 223 and 323 overlap each other in the ideal positional relation in plan view.

To take a more specific example, the widths X3 and Y3 are each 3 mm, but the dimensions of the terminal 323 are not limited to this example, and can be changed as appropriate. The widths D4 and D5 are each 0.2 mm, but the relation in size between the terminals 323 and 223 is not limited to this example, and can be changed as appropriate. When the width D4 is equal to the width D5 in this way, the terminal 223 is also square in shape, in the same way as the terminal 323. In FIG. 22, the terminals 323 are laid out as if two of the terminals 323 closer to each other share one of the outer edges of the rectangular shape in plan view, but, in practice, the terminals 323 are provided so as not to be in contact with each other. Specifically, a grid-like non-contact area in plan view is formed in the signal transmitter 520. The terminals 323 are arranged in a regularly aligned manner in the signal transmitter 520 while being separated from one another by the non-contact area. The terminals 323 and the terminals 223 overlapping the terminals 323 in plan view may be arranged in a matrix having a row-column configuration along the first direction Dx and the second direction Dy, but may be arranged in a staggered manner. That is, the term “arranged in a regularly aligned manner” in the second modification refers to, for example, a matrix arrangement or a staggered arrangement, but is not limited to these arrangements, and may be any other regular arrangement that allows the arranged terminals 323 to occupy a larger area in the signal transmitter 520. Thus, a plurality of pairs of the square-shaped terminals 223 and 323 are arranged in a regularly aligned manner in the signal transmitter 520. As described above, the second modification is the same as the first modification except that the terminals 222 and 322 are replaced with the terminals 223 and 323 in the configuration provided in the signal transmitter 520.

The relation between the terminals 221 and 321 in the embodiment, the relation between the terminals 222 and 322 in the first modification, and the relation between the terminals 223 and 323 in the second modification can exhibit coupling capacitance sizes different from one another. The term “coupling capacitance size” refers, herein, to the size of the electrostatic capacitance generated between the configuration serving as the terminal 220 and the configuration serving as the terminal 320 as described with reference to FIG. 12.

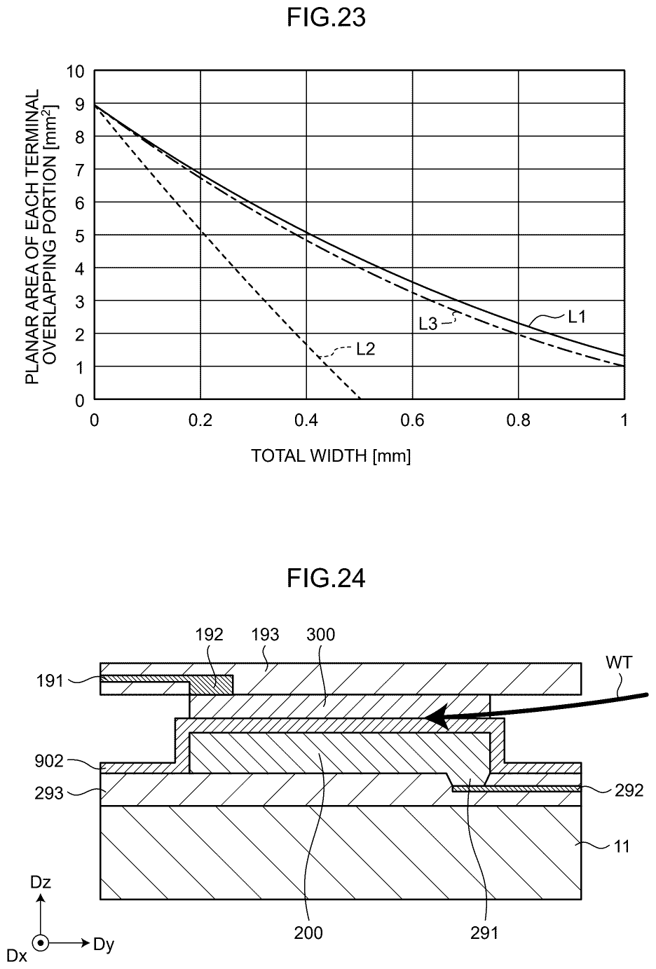

FIG. 23 is a graph illustrating a relation between the total width and the size of an overlapping area of each terminal of the terminals 220 and 320 that is a main factor for determining the coupling capacitance size. The total width is the sum of a first width and a second width. The first width is a gap width as a non-contact area between the configurations serving as the terminals 320. The second width is a width by which the configuration serving as the terminal 320 can rim the configuration serving as the terminal 220 when the terminals 220 and 320 overlap each other in the ideal positional relation. Therefore, the size of each of the widths D1, D2, D3, D4, and D5 is the size of the second width.

Graph L1 in FIG. 23 is a graph of the size of the overlapping area of each terminal of the terminals 220 and 320 that is the main factor for determining the coupling capacitance size between the terminals 221 and 321 in the embodiment. Graph L2 in FIG. 23 is a graph of the coupling capacitance size between the terminals 222 and 322 in the first modification. Graph L3 in FIG. 23 is a graph of the size of the overlapping area of each terminal of the terminals 220 and 320 that is the main factor for determining the coupling capacitance size between the terminals 223 and 323 in the second modification.

If both the first and the second widths are 0 mm, the size of the overlapping area of each terminal of the terminals 220 and 320 that is the main factor for determining the coupling capacitance of the embodiment, the first modification, and the second modification is approximately 9 mm², as illustrated on the left side of the graph in FIG. 23. In practice, however, the first width, that is, the gap width as the non-contact area between the configurations serving as the terminals 320 cannot be practically reduced to zero. Thus, the actual total width exceeds zero since the first width exceeds zero. That is, a gap of the first width is provided between the configurations serving as the terminals 320.

Assuming that the terminals 220 and 320 overlap each other in the ideal positional relation, the second width may be zero. In practice, however, when determining and supporting the facing positional relation between the first and the second terminals 200 and 300 using a gripping mechanism such as the gripping member 400, positional misalignment can occur between the configuration serving as the terminal 220 and the configuration serving as the terminal 320 in plan view. In consideration of such positional misalignment, the second width of larger than zero is provided in the embodiment, the first modification, and the second modification. That is, a gap of the total width obtained by summing the first width and the second width is provided between the configurations serving as the terminals 220. In other words, even when the misalignment occurs between the configuration serving as the terminal 220 and the configuration serving as the terminal 320 in plan view, no substantial problem occurs in the transmission of the output signals and the like, as long as the extent of the misalignment falls within the second width.

Thus, the gap of the total width is provided between the configurations serving as the terminals 220. In other words, it can be said that the signal transmitter 520 includes terminal areas provided with the configurations serving as the terminals 220 and a non-terminal area corresponding to the gap of the total width. The larger the non-terminal area, the smaller the size of the overlapping area of each terminal of the terminals 220 and 320 that is the main factor for determining the coupling capacitance size. In other words, even if the total width is the same, the coupling capacitance size can be increased by increasing the area of the shape of the configuration serving as the terminal 220. Using the same concept, even if the total width is the same, the coupling capacitance size can be increased by increasing the area of the shape of the configuration serving as the terminal 320.

Graph L1 in FIG. 23 represents the size of the overlapping area of each terminal of the terminals 220 and 320 that is the main factor for determining the coupling capacitance size larger than that of Graphs L2 and L3, in the range of the total width larger than zero. That is, by employing the hexagonal-shaped terminals 221 and 321 as in the embodiment, the coupling capacitance size can be made larger than in the first and the second modifications. Graph L3 indicates a larger coupling capacitance size than Graph L2 at the total width larger than zero. That is, by employing the square-shaped terminals 223 and 323 as in the second modification, the coupling capacitance size can be made larger than in the first modification.

The larger coupling capacitance size facilitates more reliable electrical transmission between the sensor panel 10 and the wiring of the FPC 19.

The above has described the first and the second modifications in which the shape of the configuration in the signal transmitter 520 in plan view differs in the embodiment. The following describes a third, a fourth, and a fifth modifications of the embodiment in which the configuration interposed between the first and the second terminals 200 and 300 differs from the insulating layer 90 of the embodiment, with reference to FIGS. 24 to 26. The third, the fourth, and the fifth modifications are the same as the embodiment, except that the configuration interposed between the first and the second terminals 200 and 300 differs from the insulating layer 90 of the embodiment.

### Third Modification

FIG. 24 is a sectional view of the configuration interposed between the first and the second terminals 200 and 300 in the third modification. As illustrated in FIG. 24, the configuration interposed between the first and the second terminals 200 and 300 may be only the second insulating layer 902. That is, the first insulating layer 901 of the embodiment may be omitted.

### Fourth Modification

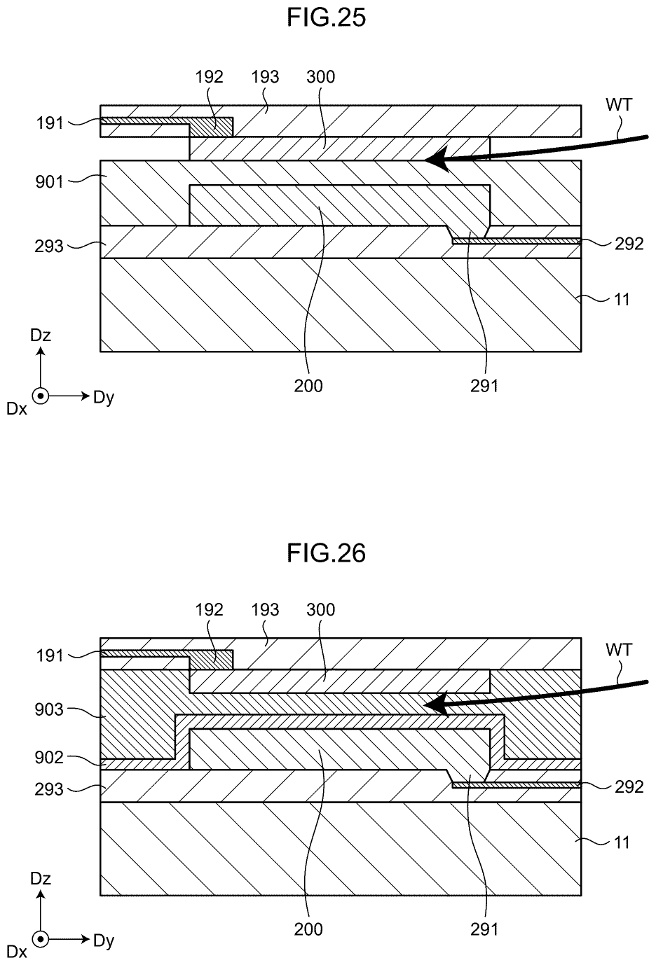

FIG. 25 is a sectional view of the configuration interposed between the first and the second terminals 200 and 300 in the fourth modification. As illustrated in FIG. 25, the configuration interposed between the first and the second terminals 200 and 300 may be only the first insulating layer 901. That is, the second insulating layer 902 of the embodiment may be omitted.

### Fifth Modification

FIG. 26 is a sectional view of the configuration interposed between the first and the second terminals 200 and 300 in the fifth modification. As illustrated in FIG. 26, the configuration interposed between the first and the second terminals 200 and 300 may be a multilayered structure of the second insulating layer 902 and an adhesive layer 903. The adhesive layer 903 is an adhesive layer that bonds the first terminal 200, which is covered by the second insulating layer 902, to the second terminal 300, and is made of adhesive tape, for example. In the fifth modification, the gripping member 400 may be omitted.

In any of the third, the fourth, and the fifth modifications, in the same way as in the embodiment, the corrosion of the first terminal 200 can be reduced even if the metal corrosive component WT such as moisture or the like enters between the first and the second terminals 200 and 300.

One of the first and the second modifications can be combined with one of the third, the fourth and the fifth modifications. That is, the configuration in the signal transmitter 520 may be the configuration of one of the first and the second modifications, and the configuration between the first and the second terminals 200 and 300 may be the configuration of one of the third, the fourth and the fifth modifications. The term “the embodiment and the like” includes the embodiment, the first modification, the second modification, the third modification, the fourth modification, the fifth modification, and “a combination of one of the first and the second modifications with one of the third, the fourth and the fifth modifications”.

As described above, according to the embodiment and the like, the detection device 1 includes the sensor panel 10 that has the detection area SA in which the optical sensors WA are two-dimensionally arranged, the light sources 22 that emit light, the member 60 on which the object to be detected SUB is to be placed so that the object to be detected SUB is interposed between the detection area SA and the light sources 22, and the FPC 19 provided with the wiring that transmits the signals to be transmitted between the sensor panel 10 and the circuit (such as the detection circuit 15) provided outside the sensor panel 10. The first terminal 200 that is a conductor coupled to the wiring (wiring line) 292 provided on the sensor panel 10 is covered by the insulating layer 90. The second terminal 300, which is a conductor provided on the FPC 19 correspondingly to the first terminal 200 and coupled to the wiring (wiring line) 191, faces the first terminal 200 with an insulating layer (such as the insulating layer 90) interposed therebetween. With this configuration, the electrical transmission path between the sensor panel 10 and the wiring of the FPC 19 is less likely to deteriorate due to corrosion.

The first and the second terminals 200 and 300 form the power transmitter 510 including the coils 210 and 310 that transmit the power through the electromagnetic induction. This configuration can reduce faults in power transmission between the sensor panel 10 and the wiring of the FPC 19.

The first and the second terminals 200 and 300 form the signal transmitter 520 that transmits signals through the electrostatic capacitance between the conductors facing each other. This configuration can reduce faults in signal transmission between the sensor panel 10 and the wiring of the FPC 19.

The areas of the terminals 221, 222, or 223 provided in the signal transmitter 520 of the first terminal 200 differ from the areas of the terminals 321, 322, or 323 provided in the signal transmitter 520 of the second terminal 300. As a result, the probability can be further reduced that the positional misalignment between the configuration serving as the terminal 220 and the configuration serving as the terminal 320 affects the electrical transmission between the sensor panel 10 and the wiring of the FPC 19.

In the signal transmitter 520 of the second modification, the square-shaped terminals 223 and 323 are arranged in a regularly aligned manner. This configuration facilitates more reliable electrical transmission between the sensor panel 10 and the wiring of the FPC 19.

In the signal transmitter 520 of the embodiment, the regular hexagonal terminals 221 and 321 are arranged in a staggered manner. This configuration facilitates more reliable electrical transmission between the sensor panel 10 and the wiring of the FPC 19.

The size relation between the terminals 220 and 320 may be reversed. The specific configuration of the mechanism, such as the gripping member 400, that maintains the facing positional relation between the first and the second terminals 200 and 300 is not limited to the mechanism described with reference to FIGS. 15 to 17, and may be mechanisms based on other specific structures as long as functioning in the same way.

Other operational advantages accruing from the aspects described in the embodiment and the like that are obvious from the description herein, or that are conceivable as appropriate by those skilled in the art will naturally be understood as accruing from the present disclosure.

What is claimed is:

1. A detection device comprising:
a sensor panel that has a detection area in which a plurality of optical sensors are two-dimensionally arranged;
a light source configured to emit light;
a member on which an object to be detected is to be placed so that the object to be detected is interposed between the detection area and the light source; and
a flexible printed circuit provided with wiring configured to transmit signals to be transmitted between the sensor panel and a circuit outside the sensor panel, wherein
a first terminal that is a conductor coupled to wiring provided on the sensor panel is covered by an insulting layer,
the first terminal and a second terminal face each other with the insulating layer interposed between the first terminal and the second terminal, and
the second terminal is a conductor that is provided on the flexible printed circuit correspondingly to the first terminal and is coupled to the wiring of the flexible printed circuit.

2. The detection device according to claim 1, wherein the first terminal and the second terminal form a power transmitter comprising coils configured to transmit power through electromagnetic induction.

3. The detection device according to claim 1, wherein the first terminal and the second terminal form a signal transmitter configured to transmit signals through electrostatic capacitance between conductors facing each other.

4. The detection device according to claim 3, wherein an area of a terminal provided in the signal transmitter of the first terminal differs from an area of a terminal provided in the signal transmitter of the second terminal.

5. The detection device according to claim 3, wherein a plurality of square-shaped terminals are arranged in a regularly aligned manner in the signal transmitter.

6. The detection device according to claim 3, wherein regular hexagonal terminals are arranged in a staggered manner in the signal transmitter.
